(19) United States
(12) Patent Application Publication
(10) Pub. No.: US 2016/0232859 A1
(43) Pub. Date: Aug. 11, 2016

(54) DISPLAY APPARATUS AND METHOD OF DRIVING THE SAME

(71) Applicant: Samsung Display Co., Ltd., Yongin-City (KR)

(72) Inventors: Won-Sik OH, Songpa-gu (KR); Cheol-Woo PARK, Suwon-si (KR); Jai-Hyun KOH, Hwaseong-si (KR); Kuk-Hwan AHN, Hwaseong-si (KR)

(21) Appl. No.: 14/742,848

(22) Filed: Jun. 18, 2015

(30) Foreign Application Priority Data
Feb. 11, 2015 (KR) 10-2015-0021014

(51) Int. Cl. G09G 3/36

(52) U.S. Cl. CPC G09G 3/3607; G09G 3/3688; G09G 2300/0443; G09G 2300/0452; G09G 2310/027; G09G 2320/0242; G09G 2320/0233

(57) ABSTRACT

A display apparatus comprises a display panel including a plurality of color sub-pixels which are arranged as a plurality of sub-pixel columns and a plurality of sub-pixel rows, a first pixel column and a second pixel column which include a plurality of sub-pixel columns, a luminance controller configured to correct color grayscale data of at least one color sub-pixel included in at least one of the first and second pixel columns by 1-grayscale based on a luminance difference between the first and second pixel columns, and a data driver configured to convert the color grayscale data of the color sub-pixel to a data voltage and to provide the display panel with the data voltage.

This application claims priority from and the all benefits accruing under 35 U.S.C. §119 from an application earlier filed in the Korean Patent Office as Korean Patent Application No. 10-2015-0021014 filed on Feb. 11, 2015, which is hereby incorporated by reference for all purposes as if fully set forth herein.

### BACKGROUND OF THE INVENTION

1. Field of the Invention

The present invention relates to a display apparatus and a method of driving the display apparatus. More particularly, example embodiments of the present invention relate to a display apparatus for improving a display quality and a method of driving the display apparatus.

2. Description of the Related Art

A liquid crystal display (“LCD”) apparatus includes an LCD panel and a driver apparatus configured to drive the LCD panel. The LCD panel includes a plurality of data lines and a plurality of gate lines crossing the data lines. The data lines and the gate lines may define a plurality of pixels.

The driver apparatus includes a gate driver configured to output a gate signal to a gate line and a data driver configured to output a data signal to a data line. The driver apparatus may drive the LCD panel in an inversion mode to prevent the LCD panel from being damaged. In the inversion mode, the polarity of a data voltage applied to a pixel may be reversed.

In the LCD apparatus, a display defect such as a vertical line may occur by a pixel connection structure and a process deviation.

### SUMMARY OF THE INVENTION

Exemplary embodiments of the present invention provide a display apparatus for improving a display quality.

Exemplary embodiments of the present invention provide a method of driving the display apparatus.

According to an exemplary embodiment of the present invention, there is provided a display apparatus. The display apparatus includes a display panel comprising a plurality of color sub-pixels which is arranged as a plurality of sub-pixel columns and a plurality of sub-pixel rows, a first pixel column and a second pixel column which comprise a plurality of sub-pixel columns, a luminance controller configured to correct color grayscale data of at least one color sub-pixel included in at least one of the first and second pixel columns by 1-grayscale based on a luminance difference between the first and second pixel columns, and a data driver configured to convert the color grayscale data of the color sub-pixel to a data voltage and to provide the display panel with the data voltage.

In an exemplary embodiment, color sub-pixels in a sub-pixel row may be alternately connected to an upper gate line disposed at an upper side of the sub-pixel row and a lower gate line disposed at a lower side of the sub-pixel row, the first pixel column may include color sub-pixels of an even number which are connected to corresponding upper gate lines and consecutively arranged, and the second pixel column may include color sub-pixels of an even number which are connected to corresponding lower gate lines and consecutively arranged.

In an exemplary embodiment, the luminance difference may correspond to a grayscale smaller than 1-grayscale.

In an exemplary embodiment, the color sub-pixels may include red, green, blue and white sub-pixels.

In an exemplary embodiment, the luminance controller may determine at least one of red, green, blue and white grayscale data of the red, green, blue and white sub-pixels so as to compensate for the luminance difference based on a luminance proportion of the red, green, blue and white colors.

In an exemplary embodiment, the luminance controller may be configured to correct one of red, green, blue and white grayscale data of the red, green, blue and white sub-pixels in the first pixel column by 1-grayscale, and not to correct red, green, blue and white grayscale data of the red, green, blue and white sub-pixels in the second pixel column.

In an exemplary embodiment, the luminance controller may be configured to correct one of red, green, blue and white grayscale data of the red, green, blue and white sub-pixels in the second pixel column by 1-grayscale, and not to correct red, green, blue and white grayscale data of the red, green, blue and white sub-pixels in the first pixel column.

In an exemplary embodiment, the luminance controller may be configured to correct color grayscale data of half of a predetermined color sub-pixel in the first pixel column by 1-grayscale, and to correct color grayscale data of half of the predetermined color sub-pixel in the second pixel column by 1-grayscale.

In an exemplary embodiment, the luminance controller may be configured to correct white grayscale data of the white sub-pixels in the first pixel column by 1-grayscale, and not to correct red, green, blue and white grayscale data of the red, green, blue and white sub-pixels in the second pixel column.

In an exemplary embodiment, the luminance controller may be configured to correct white grayscale data of the white sub-pixels in the second pixel column by 1-grayscale, and not to correct red, green, blue and white grayscale data of the red, green, blue and white sub-pixels in the first pixel column.

In an exemplary embodiment, the luminance controller may be configured to correct white grayscale data of half of the white sub-pixels in the first pixel column by 1-grayscale, and to correct white grayscale data of half of the white sub-pixels in the second pixel column by 1-grayscale.

According to an exemplary embodiment of the present invention, there is provided a method of driving the display apparatus. The method includes correcting color grayscale data of at least one color sub-pixel included in at least one of first and second pixel columns by 1-grayscale based on a luminance difference between the first and second pixel columns. A display panel comprises a plurality of color sub-pixels which is arranged as a plurality of sub-pixel columns and a plurality of sub-pixel rows. Each of the first and second pixel columns comprises a plurality of sub-pixel columns, and converts the color grayscale data of the color sub-pixel to a data voltage to provide the display panel with the data voltage.

In an exemplary embodiment, color sub-pixels in a sub-pixel row may be alternately connected to an upper gate line disposed at an upper side of the sub-pixel row and a lower gate line disposed at a lower side of the sub-pixel row. The first pixel column may include color sub-pixels of an even number which are connected to corresponding upper gate lines and consecutively arranged, and the second pixel column may include color sub-pixels of an even number which are connected to corresponding lower gate lines and consecutively arranged.

In an exemplary embodiment, the luminance difference may correspond to a grayscale smaller than 1-grayscale.

In an exemplary embodiment, the method may further include correcting one of red, green, blue and white grayscale data of the red, green, blue and white sub-pixels in the first pixel column by 1-grayscale, and not to correcting red, green, blue and white grayscale data of the red, green, blue and white sub-pixels in the second pixel column.

In an exemplary embodiment, the method may further include correcting one of red, green, blue and white grayscale data of the red, green, blue and white sub-pixels in the second pixel column by 1-grayscale, and not to correcting red, green, blue and white grayscale data of the red, green, blue and white sub-pixels in the first pixel column.

In an exemplary embodiment, the method may further include correcting color grayscale data of half of a predetermined color sub-pixel in the first pixel column by 1-grayscale, and correcting color grayscale data of half of the predetermined color sub-pixel in the second pixel column by 1-grayscale.

In an exemplary embodiment, the method may further include correcting white grayscale data of the white sub-pixels in the first pixel column by 1-grayscale, and not correcting red, green, blue and white grayscale data of the red, green, blue and white sub-pixels in the second pixel column.

In an exemplary embodiment, the method may further include correcting white grayscale data of the white sub-pixels in the second pixel column by 1-grayscale, and not to correcting red, green, blue and white grayscale data of the red, green, blue and white sub-pixels in the first pixel column.

In an exemplary embodiment, the method may further include correcting white grayscale data of half of the white sub-pixels in the first pixel column by 1-grayscale, and correcting white grayscale data of half of the white sub-pixels in the second pixel column by 1-grayscale.

According to the present invention, the vertical line defect which corresponds to the luminance difference between the first pixel column, including the color sub-pixels connected to the upper gate line, and the second pixel column, including the color sub-pixels connected to the lower gate line, may be decreased or eliminated. In addition, the color grayscale data of at least one of the red, green, blue and white color sub-pixels included in at least one of the first pixel column and the second pixel column are corrected by the grayscale less than 1-grayscale such that the luminance difference may be decreased or eliminated.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a display apparatus according to an exemplary embodiment of the invention;

FIG. 2 is a conceptual diagram illustrating a display panel of FIG. 1;

FIGS. 3A to 3D are conceptual diagrams illustrating a luminance difference between first and second pixel columns according to a comparative example embodiment;

FIG. 4 is a conceptual diagram illustrating a unit cell for compensating a luminance according to a luminance controller of FIG. 1;

FIG. 5 is a conceptual diagram illustrating a method of correcting the luminance difference according to an exemplary embodiment of the invention;

FIG. 6 is a conceptual diagram illustrating a method of correcting the luminance difference according to an exemplary embodiment of the invention; and

FIG. 7 is a conceptual diagram illustrating a method of correcting the luminance difference according to an exemplary embodiment of the invention.

### DETAILED DESCRIPTION OF THE INVENTION

Hereinafter, the present invention will be explained in detail with reference to the accompanying drawings.

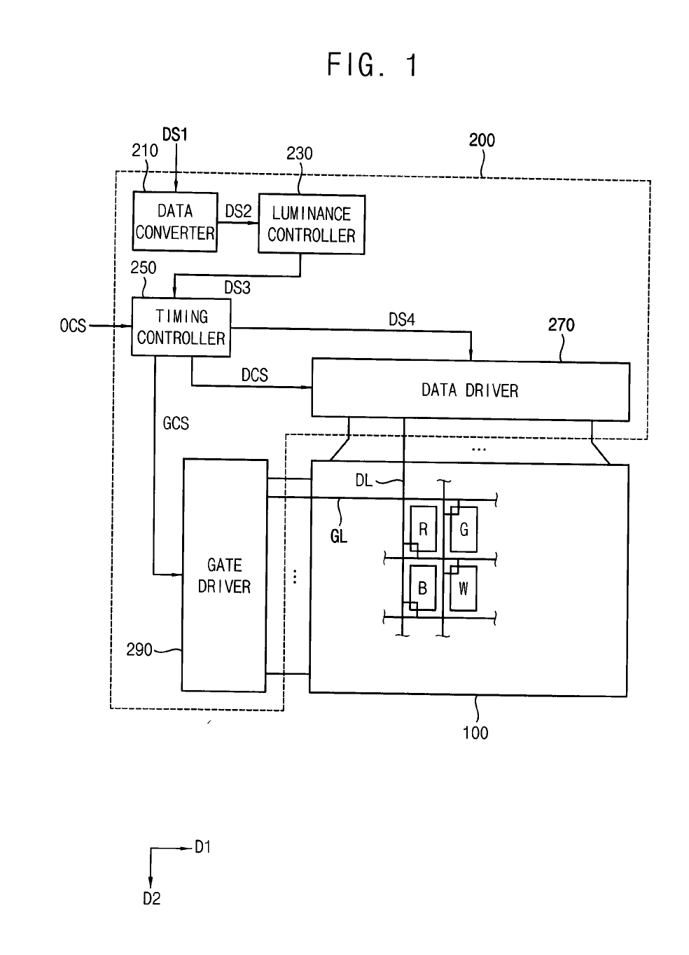

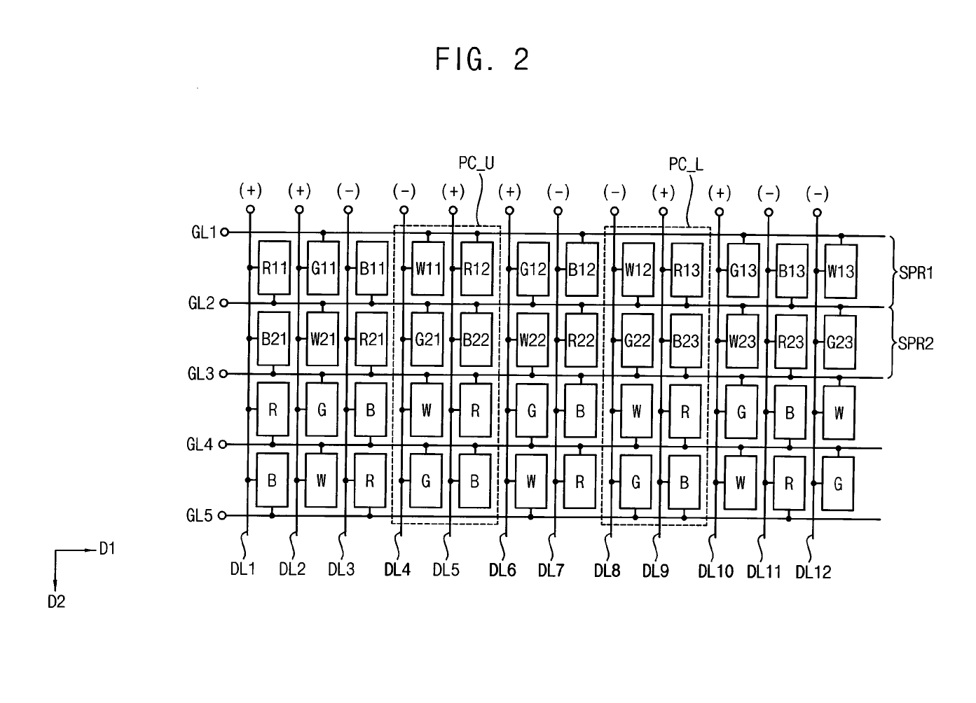

FIG. 1 is a block diagram illustrating a display apparatus according to an exemplary embodiment of the invention, and FIG. 2 is a conceptual diagram illustrating a display panel of FIG. 1.

Referring to FIGS. 1 and 2, the display apparatus may include a display panel 100 and a panel driving unit 200.

The display panel 100 may include a plurality of data lines DL, a plurality of gate lines GL and a plurality of pixels P.

The plurality of data lines DL extends in a first direction D1 and is arranged in a second direction D2 crossing the first direction D1.

The plurality of gate lines GL extends in the second direction D2 and is arranged in the first direction D1.

Each of the pixels P may include color sub-pixels of an even number. For example, a pixel P includes a red sub-pixel R, a green sub-pixel G, a blue sub-pixel B and a white sub-pixel W. A color sub-pixel is defined by first and second sides opposite to each other in the first direction D1 and third and fourth sides opposite to each other in the second direction D2.

The color sub-pixels are connected to a data line adjacent to one of the first and second sides, and are alternately connected to both gate lines adjacent to the third and fourth sides.

For example, as shown in FIG. 2, a sub-pixel row is defined by color sub-pixels which are arranged in the first direction D1 and a sub-pixel column is defined by color sub-pixels which are arranged in the second direction D2.

A first sub-pixel row SPR1 includes a first red sub-pixel R11, a first green sub-pixel G11, a first blue sub-pixel B11, a first white sub-pixel W11, a second red sub-pixel R12, a second green sub-pixel G12, a second blue sub-pixel B12, a second white sub-pixel W12, a third red sub-pixel R13, a third green sub-pixel G13, a third blue sub-pixel B13 and a third white sub-pixel W13.

The first red sub-pixel R11 is connected to a second gate line GL2, which is the lower gate line of both gate lines and to a first data line DL1. The first green sub-pixel G11 is connected to a first gate line GL1, which is the upper gate line of both gate lines, and to a second data line DL2. The first blue sub-pixel B11 is connected to the second gate line GL2 and to a third data line DL3. The first white sub-pixel W11 is connected to the first gate line GL1 and to a fourth data line DL4.

The second red sub-pixel R12 is connected to the first gate line GL1, which is the upper gate line of both gate lines, and to a fifth data line DL5. The second green sub-pixel G12 is connected to the second gate line GL2 and to a sixth data line DL6. The second blue sub-pixel B12 is connected to the first gate line GL1 and to a seventh data line DL7. The second white sub-pixel W12 is connected to the second gate line GL2 and to an eighth data line DL8.

The third red sub-pixel R13 is connected to the second gate line GL2, which is the lower gate line of both gate lines, and to a ninth data line DL9. The third green sub-pixel G13 is connected to the first gate line GL1 and to a tenth data line DL10. The third blue sub-pixel B13 is connected to the second gate line GL2 and to an eleventh data line DL11. The third white sub-pixel W13 is connected to the first gate line GL1 and to a twelfth data line DL12.

The second sub-pixel row SPR2 includes a fourth blue sub-pixel B21, a fourth white sub-pixel W21, a fourth red sub-pixel R21, a fourth green sub-pixel G21, a fifth blue sub-pixel B22, a fifth white sub-pixel W22, a fifth red sub-pixel R22, a fifth green sub-pixel G22, a sixth blue sub-pixel B23, a sixth white sub-pixel W23, a sixth red sub-pixel R23 and a sixth green sub-pixel G23.

The fourth blue sub-pixel B21 is connected to a third gate line GL3, which is the lower gate line of both gate lines, and to the first data line DL1. The fourth white sub-pixel W21 is connected to the second gate line GL2, which is the upper gate line of both gate lines, and to the second data line DL2. The fourth red sub-pixel R21 is connected to the third gate line GL3 and to the third data line DL3. The fourth green sub-pixel G21 is connected to the second gate line GL2 and to the fourth data line DL4.

The fifth blue sub-pixel B22 is connected to the second gate line GL2, which is the upper gate line of both gate lines, and to the fifth data line DL5. The fifth white sub-pixel W22 is connected to the third gate line GL3 and to the sixth data line DL6. The fifth red sub-pixel R22 is connected to the second gate line GL2 and to the seventh data line DL7. The fifth green sub-pixel G22 is connected to the third gate line GL3 and to the eighth data line DL8.

The sixth blue sub-pixel B23 is connected to the third gate line GL3, which is the lower gate line of both gate lines, and to the ninth data line DL9. The sixth white sub-pixel W23 is connected to the second gate line GL2 and to the tenth data line DL10. The sixth red sub-pixel R23 is connected to the third gate line GL3 and to the eleventh data line DL11. The sixth green sub-pixel G23 is connected to the second gate line GL2 and to the twelfth data line DL12.

As shown in FIG. 2, for example, color sub-pixels in a first sub-pixel row SPR1 may be alternately connected to the upper and lower gate lines. However, the second red sub-pixel R12, adjacent to the first white sub-pixel W11, is connected to the first gate line GL1 which is the upper gate line such as the first white sub-pixel W11. In addition, the third red sub-pixel R13, adjacent to the second white sub-pixel W12, is connected to the second gate line GL2 which is the lower gate line such as the second white sub-pixel W12.

As described above, by a sub-pixel structure and a process deviation, a first pixel column PC_U, including the first white sub-pixel W11 and the second red sub-pixel R12, displays an image of a relatively high luminance, and a second pixel column PC_L, including the second white sub-pixel W12 and the third red sub-pixel R13, displays an image of a relatively low luminance. Thus, an image displayed on the display panel 100 may have a vertical line defect.

The panel driving unit 200 of FIG. 1 may include a data converter 210, a luminance controller 230, a timing controller 250, a data driver 270 and a gate driver 290.

The data converter 210 is configured to convert first color grayscale data received form an external device to second color grayscale data in correspondence to an RGBW sub-pixel structure of the display panel 100. For example, the first color grayscale data include red, green and blue grayscale data DS1 and the second color grayscale data include red, green, blue and white grayscale data DS2.

The luminance controller 230 is configured to compensate for a luminance difference between images which are respectively displayed on the first pixel column PC_U and the second pixel column PC_L. The images displayed on the first and second pixel columns PC_U and PC_L, respectively, may have a grayscale difference of less than or equal to 1-grayscale.

The luminance controller 230 is configured to correct color grayscale data of at least one color of red, green, blue and white sub pixels included in at least one of the first and second pixel columns PC_U and PC_L (DS3), respectively,

In addition, the luminance controller 230 is configured to correct color grayscale data in correspondence to at least one color of red, green, blue and white sub pixels included in all of the first and second pixel columns PC_U and PC_L (DS3), respectively,

The timing controller 250 is configured to receive an original control signal OCS from the external device. The timing controller 250 is configured to generate a timing control signal for controlling a driving timing of the display panel 100 using the received original control signal OCS. The timing control signal may include a data control signal DCS for controlling a driving timing of the data driver 270 and a gate control signal GCS for controlling a driving timing of the gate driver 290.

The data control signal DCS may include a horizontal synch signal, a vertical synch signal, a load signal, an inversion control signal, a dot clock signal, and so on. The gate control signal GCS may include a vertical start signal, at least one gate clock signal, a gate output enable signal and so on.

In addition, the timing controller 250 is configured to correct red, green, blue and white grayscale data (DS3) provided by the luminance controller 230 using various algorithms (DS4). The corrected red, green, blue and white grayscale data (DS4) is provides to the data driver 270.

The data driver 270 is configured to convert the red, green, blue and white grayscale data (DS4) provided by the timing controller 250 into red, green, blue and white data voltages which are analog voltages, and to output the red, green, blue and white data voltages of a positive polarity (+) or a negative polarity (−) based on the inversion control signal.

According to the exemplary embodiment, during a frame, color sub-pixels connected to the first and second data lines DL1 and DL2, respectively, receive the data voltage of the positive polarity (+), and color sub-pixels connected to the third and fourth data lines DL3 and DL4, respectively, receive the data voltage of the negative polarity (−).

As described above, the data driver 270 is configured to output the data voltages of a repetitive polarity by four data lines to the plurality of data lines of the display panel 100.

The gate driver 290 is configured to generate a gate signal having a gate-on voltage and a gate-off voltage based on the gate control signal, and to output the gate signal to the plurality of gate lines of the display panel 100 along a scan direction.

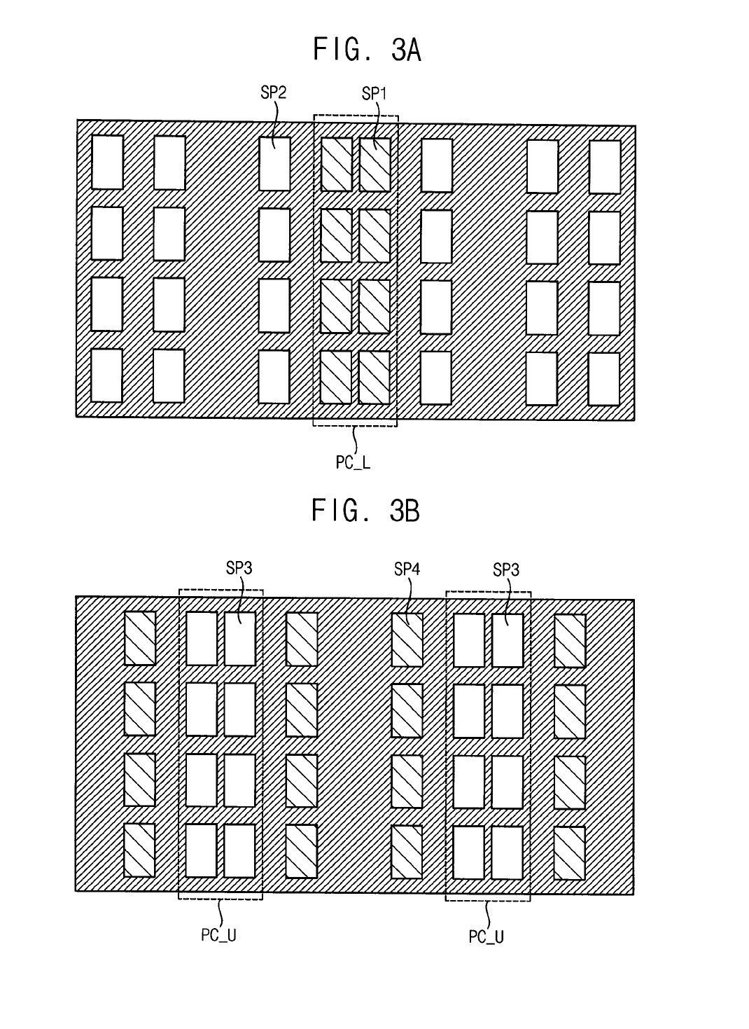

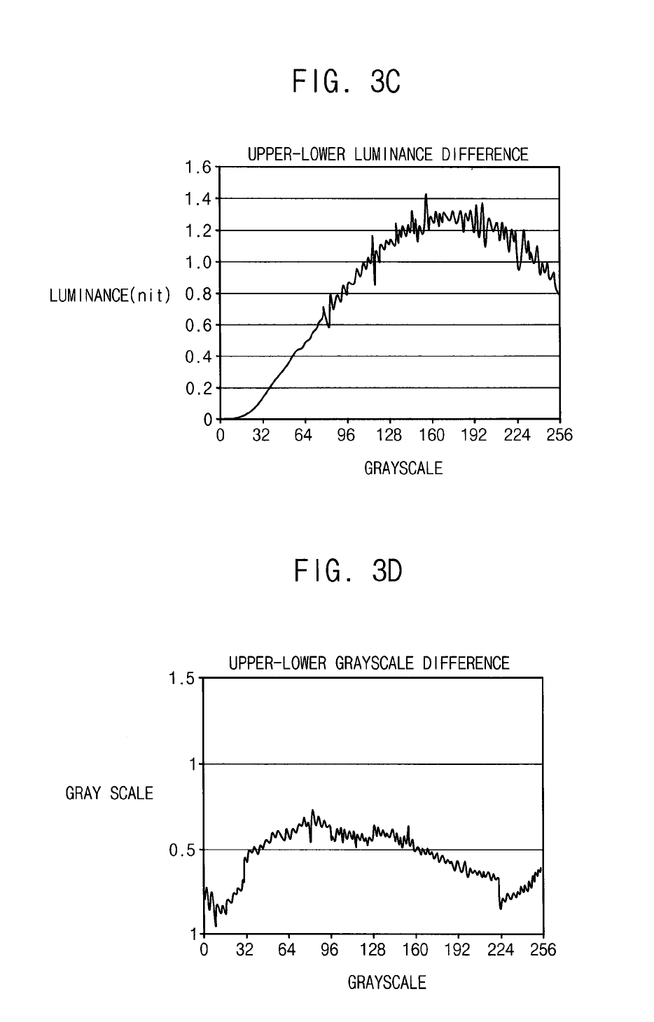

FIGS. 3A to 3D are conceptual diagrams illustrating a luminance difference between first and second pixel columns according to a comparative example embodiment.

FIG. 3A is a conceptual diagram illustrating when color sub-pixels connected to the lower gate lines as shown in FIG. 2 are driven, and FIG. 3B is a conceptual diagram illustrating when color sub-pixels connected to the upper gate lines, as shown in FIG. 2, are driven.

Referring to FIG. 3A, an image displayed on the color sub-pixels SP1 in the second pixel column PC_L, which are successively connected to the lower gate lines, has a low luminance lower than an image displayed on color sub-pixels SP2 which are connected to the lower gate lines and adjacent to the color sub-pixels connected to the upper gate lines.

Referring to FIG. 3B, an image displayed on the color sub-pixels SP3 in the first pixel column PC_U, which are successively connected to the upper gate lines, has a high luminance higher than an image displayed on color sub-pixels SP4 which are connected to the upper gate lines and adjacent to the color sub-pixels connected to the lower gate lines.

FIG. 3C is a graph diagram illustrating a luminance difference between the first and second pixel columns PC_U and PC_L, respectively, according to a grayscale, and FIG. 3D is a graph diagram illustrating a grayscale difference between the first and second pixel columns PC_U and PC_L, respectively, according to a grayscale.

Referring to FIGS. 3C and 3D, the luminance difference between the first and second pixel columns PC_U and PC_L, respectively, is the largest luminance difference in a middle grayscale range. When the luminance difference is converted into the grayscale difference, the grayscale difference between the first and second pixel columns PC_U and PC_L, respectively, has a grayscale difference being smaller than 1-grayscale in the middle grayscale range.

The grayscale difference between the first and second pixel columns PC_U and PC_L, respectively, is more than about 0.5-grayscale and less than about 1-grayscale in a range which is from about 40-grayscale to about 160-grayscale. The grayscale difference between the first and second pixel columns PC_U and PC_L, respectively, is less than about 0.5 grayscale in a range which is less than or equal to about 40 grayscale and more than or equal to about 160 grayscale.

Thus, when the grayscale difference between the first and second pixel columns PC_U and PC_L, respectively, may be compensated, the luminance difference such as the vertical line defect may be compensated.

According to the exemplary embodiment, a grayscale correction value for correcting grayscale date of the pixel may be less than 1-grayscale based on a luminance proportion of red, green, blue and white colors affecting the luminance.

The luminance proportion (R:G:B:W) of the red, green, blue and white colors is about (2:7:1:10). When the red grayscale data increase by 1-grayscale, the luminance of the pixel may be increased in correspondence to about (2/20)-grayscale that is 0.1-grayscale. When the green grayscale data increase by 1-grayscale, the luminance of the pixel may be increased in correspondence to about (7/20)-grayscale that is 0.35-grayscale. When the blue grayscale data increase by 1-grayscale, the luminance of the pixel may be increased in correspondence to about (1/20)-grayscale that is 0.05-grayscale. When the white grayscale data increase 1-grayscale, the luminance of the pixel may be increased in correspondence to about (10/20)-grayscale that is 0.5 grayscale.

However, when the red grayscale data decrease by 1-grayscale, the luminance of the pixel may be decreased in correspondence to about 0.1-grayscale. When the green grayscale data decrease by 1-grayscale, the luminance of the pixel may be decreased in correspondence to about 0.35-grayscale. When the blue grayscale data decrease by 1-grayscale, the luminance of the pixel may be decreased in correspondence to about 0.05-grayscale. When the white grayscale data decrease by 1-grayscale, the luminance of the pixel may be decreased in correspondence to about 0.5-grayscale.

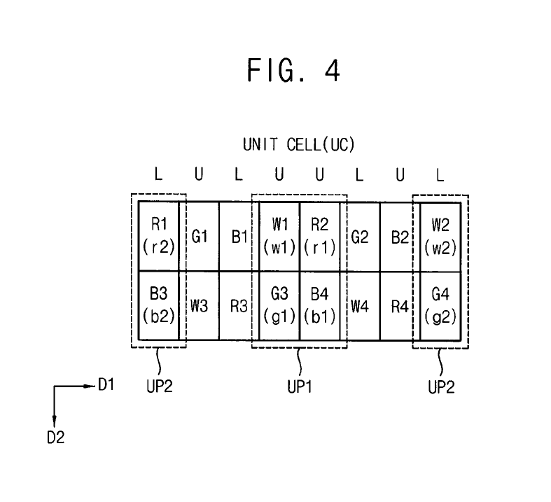

FIG. 4 is a conceptual diagram illustrating a unit cell for compensating a luminance according to a luminance controller of FIG. 1.

Referring to FIG. 4, the unit cell UC includes color sub-pixels which are arranged in a matrix shape such as an 8×2 matrix type. The unit cell UC includes a first red sub-pixel R1, a first green sub-pixel G1, a first blue sub-pixel B1, a first white sub-pixel W1, a second red sub-pixel R2, a second green sub-pixel G2, a second blue sub-pixel B2 and a second white sub-pixel W2 which are arranged in a first direction D1. The first red sub-pixel R1 is connected to a lower gate line L, the first green sub-pixel G1 is connected to an upper gate line U, the first blue sub-pixel B1 is connected to the lower gate line L, the first white sub-pixel W1 is connected to the upper gate line U, the second red sub-pixel R2 is connected to the upper gate line U, the second green sub-pixel G2 is connected to the lower gate line, the second blue sub-pixel B2 is connected to the upper gate line, and the second white sub-pixel W2 is connected to the lower gate line.

In addition, the unit cell UC includes a third blue sub-pixel B3, a third white sub-pixel W3, a third red sub-pixel R3, a third green sub-pixel G3, a fourth blue sub-pixel B4, a fourth white sub-pixel W4, a fourth red sub-pixel R4 and a fourth green sub-pixel G4. The third blue sub-pixel B3 is adjacent to the first red sub-pixel R1 in a second direction D2 crossing the first direction D1 and is connected to a lower gate line L, the third white sub-pixel W3 is adjacent to the first green sub-pixel G1 in the second direction D2 and is connected to an upper gate line U, the third red sub-pixel R3 is adjacent to the first blue sub-pixel B1 in the second direction D2 and is connected to the lower gate line L, the third green sub-pixel G3 is adjacent to the first white sub-pixel W1 in the second direction D2 and is connected to the upper gate line U, the fourth blue sub-pixel B4 is adjacent to the second red sub-pixel R2 in the second direction D2 and is connected to the upper gate line U, the fourth white sub-pixel W4 is adjacent to the second green sub-pixel G2 in the second direction D2 and connected to the lower gate line, the fourth red sub-pixel R4 is adjacent to the second blue sub-pixel B2 in the second direction D2 and is connected to the upper gate line U, and the fourth green sub-pixel G4 is adjacent to the second white sub-pixel W2 in the second direction D2 and is connected to the fourth green sub-pixel G4.

As shown in FIG. 4, the unit cell UC includes a first unit pixel UP1 including the second red, third green, fourth blue and first white sub-pixels R2, G3, B4 and W1, respectively, which are connected to the upper gate line and a second unit pixel UP2 including the first red, fourth green, third blue and second white sub-pixels R1, G4, B3 and W2, respectively, which are connected to the lower gate line.

The first unit pixel UP1 corresponds to the first pixel column PC_U shown in FIG. 2 and the second unit pixel UP2 corresponds to the second pixel column PC_L shown in FIG. 2. The first pixel column PC_U displays a relatively high luminance and the second pixel column PC_L displays a relatively low luminance. Thus, in order to compensate for the luminance difference between the first and second pixel columns PC_U and PC_L, respectively, first red, at least one of first green, first blue and first white grayscale correction values r1, g1, b1 and w1, respectively, is determined for decreasing the luminance of the first unit pixel UP1, and at least one of second red, second green, second blue and second white grayscale correction values r2, g2, b2 and w2, respectively, are determined for increasing the luminance of the second unit pixel UP2.

For example, a method of calculating the grayscale correction values may include measuring the luminance difference between the first and second pixel columns PC_U and PC_L, respectively, according to the display panel, calculating the grayscale difference in correspondence to the luminance difference between first and second unit pixels UP1 and UP2, respectively, and calculating a grayscale correction value for compensating color grayscale data of at least one of the red, green, blue and white sub-pixels in the first and second unit pixels UP1 and UP2, respectively, based on the grayscale difference.

The luminance controller 230 as shown in FIG. 1 is configured to store the grayscale correction values described above. The luminance controller 230 is configured to correct the color grayscale data of the color sub pixel included in at least one of the first and second pixel columns PC_U and PC_L, respectively, using the grayscale correction value so that the luminance difference between the first and second pixel columns PC_U and PC_L, respectively, may be compensated.

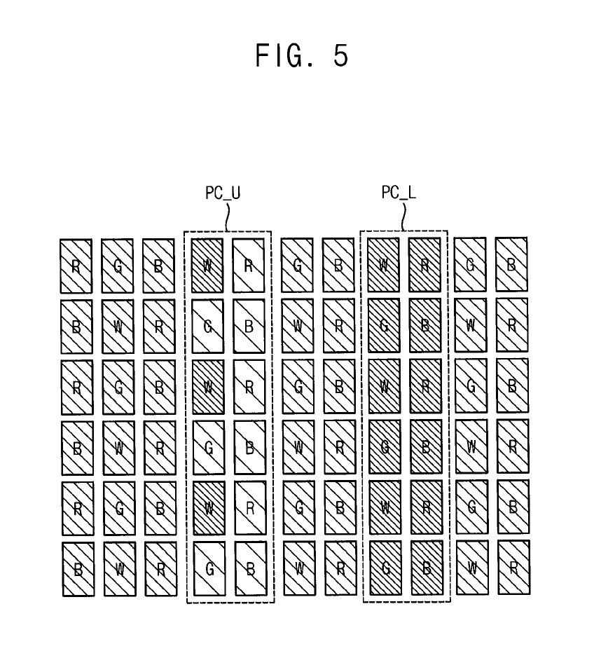

FIG. 5 is a conceptual diagram illustrating a method of correcting the luminance difference according to an exemplary embodiment of the invention.

Referring to FIG. 5, when the grayscale difference corresponding to the luminance difference between the first and second pixel columns PC_U and PC_L, respectively, is 0.5-grayscale, the luminance of the first pixel column PC_U decrease so as to compensate for the grayscale difference of 0.5 grayscale.

According to the exemplary embodiment, the luminance controller 230 shown in FIG. 1 includes a plurality of grayscale correction values for compensating a 0.5-grayscale difference between the first and second pixel columns PC_U and PC_L, respectively, calculated based on the luminance proportion (2:7:1:10) of the red, green, blue and white colors. As shown in FIG. 4, the plurality of grayscale correction values includes first red, first green, first blue and first white grayscale correction values r1, g1, b1 and w1, respectively, corresponding to the first unit pixel UP1 and second red, second green, second blue and second white grayscale correction values r2, g2, b2 and w2, respectively, corresponding to the second unit pixel UP2.

Referring to FIG. 4, according to the exemplary embodiment, in order that the high luminance of the first pixel column PC_U decrease by 0.5-grayscale, the white grayscale data of the white sub-pixel included in the first unit pixel UP1 are decreased by 1-grayscale. The first white grayscale correction value w1 is determined to be “−1”. Then, the first red, first green and first blue coefficient correction values r1, g1 and b1, respectively, corresponding to the first unit pixel UP1 and the second red, second green, second blue and second white coefficient correction values r2, g2, b2 and w2, respectively, corresponding to the second unit pixel UP2 are determined to be “0”.

Thus, as shown in FIG. 5, the white sub-pixels W included in the first pixel column PC_U of the display panel have a luminance which is decreased by 1-grayscale. Based on the luminance proportion (2:7:1:10), the first pixel column PC_U has the luminance which is decreased by 0.5-grayscale and thus the luminance difference between the first and second pixel columns PC_U and PC_L, respectively, may be decreased or eliminated.

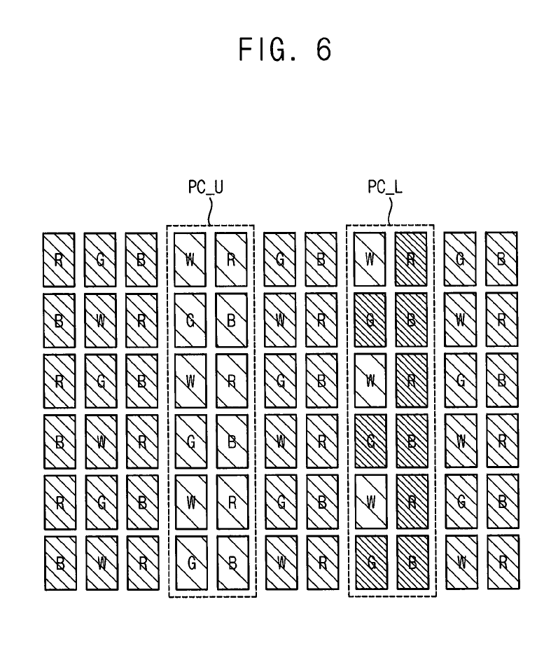

FIG. 6 is a conceptual diagram illustrating a method of correcting the luminance difference according to an exemplary embodiment of the invention.

Referring to FIG. 6, when the grayscale difference corresponding to the luminance difference between the first and second pixel columns PC_U and PC_L, respectively, is 0.5-grayscale, the luminance of the second pixel column PC_L increases to compensate for the grayscale difference of 0.5-grayscale.

Referring to FIG. 4, according to the exemplary embodiment, in order that the low luminance of the second pixel column PC_L increase by 0.5-grayscale, the white grayscale data of the white sub-pixel included in the second unit pixel UP2 are increased by 1-grayscale. Thus, the second white grayscale correction value w2 is determined to be “+1”. Then, the second red, second green and second blue coefficient correction values r2, g2 and b2, respectively, corresponding to the second unit pixel UP2 and the first red, first green, first blue and first white coefficient correction values r1, g1, b1 and w1, respectively, corresponding to the first unit pixel UP1 are determined to be “0”.

Thus, as shown in FIG. 6, the white sub-pixels W included in the second pixel column PC_L of the display panel have a luminance which is increased by 1-grayscale. Based on the luminance proportion (2:7:1:10), the second pixel column PC_L has the luminance which is increased by 0.5-grayscale, and thus the luminance difference between the first and second pixel columns PC_U and PC_L, respectively, may be decreased or eliminated.

Table 1 represents grayscale correction values respectively corresponding to various luminance differences according to various exemplary embodiments as follows:

TABLE 1

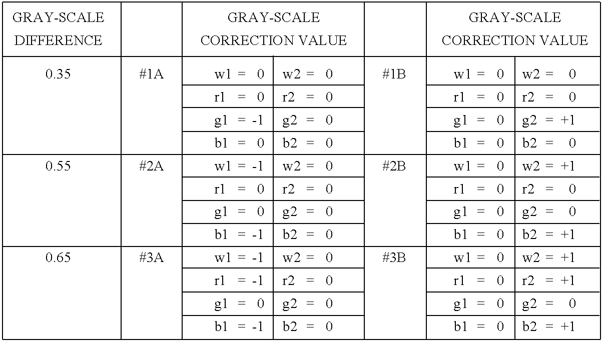

Referring to Table 1, each of exemplary embodiments #1A and #1B has a 0.35-grayscale difference which is a luminance difference between the first and second pixel columns PC_U and PC_L, respectively. According to the exemplary embodiments #1A and #1B, green grayscale data are corrected to compensate for the 0.35-grayscale difference based on the luminance proportion (2:7:1:10) of the red, green, blue and white colors.

Referring to FIG. 4, according to the exemplary embodiment #1A, green grayscale data of the green sub-pixel included in the first unit pixel UP1 are decreased by 1-grayscale in order that the luminance of the first pixel column PC_U having a high luminance decreases by 0.35-grayscale. Thus, the first green grayscale correction value g1 is determined to be “−1”. Then, the first red, first blue and first white coefficient correction values r1, b1 and w1, respectively, corresponding to the first unit pixel UP1 and the second red, second green, second blue and second white coefficient correction values r2, g2, b2 and w2, respectively, corresponding to the second unit pixel UP2 are determined to be “0”.

Therefore, the green sub-pixel included in the first pixel column PC_U has a low luminance decreased by 1-grayscale and the first pixel column PC_U has a low luminance decreased by 0.35-grayscale. Thus, the luminance difference between the first and second pixel columns PC_U and PC_L, respectively, may be decreased or eliminated.

Referring to FIG. 4, according to the exemplary embodiment #1B, green grayscale data of the green sub-pixel included in the second unit pixel UP2 are increased by 1-grayscale in order that the luminance of the second unit pixel UP2 having a low luminance increases by the 0.35-grayscale. Thus, the second green grayscale correction value g2 is determined to be “+1”. Then, the second red, second blue and second white coefficient correction values r2, b2 and w2, respectively, corresponding to the second unit pixel UP2 and the first red, first green, first blue and first white coefficient correction values r1, g1, b1 and w1, respectively, corresponding to the first unit pixel UP1 are determined to be “0”.

Therefore, the green sub-pixel included in the second pixel column PC_L has a high luminance increased by 1-grayscale and the second pixel column PC_L has a high luminance increased by 0.35-grayscale. Thus, the luminance difference between the first and second pixel columns PC_U and PC_L, respectively, may be decreased or eliminated.

Each of exemplary embodiments #2A and #2B has a 0.55-grayscale difference which is a luminance difference between the first and second pixel columns PC_U and PC_L, respectively. According to the exemplary embodiments #2A and #2B, green grayscale data are corrected to compensate for the 0.55-grayscale difference based on the luminance proportion (2:7:1:10) of the red, green, blue and white colors.

Referring to FIG. 4, according to the exemplary embodiment #2A, white and blue grayscale data of the white and blue pixels included in the first unit pixel UP1 are decreased by 1-grayscale in order that the luminance of the first pixel column PC_U having a high luminance decreases by 0.55-grayscale. Thus, the first white and first blue grayscale correction values w1 and b1, respectively, are determined to be “−1”. Then, the first red and first green coefficient correction values r1 and g1, respectively, corresponding to the first unit pixel UP1 and the second red, second green, second blue and second white coefficient correction values r2, g2, b2 and w2, respectively, corresponding to the second unit pixel UP2 are determined to be “0”.

Therefore, the white and blue sub-pixels included in the first pixel column PC_U have a low luminance decreased by 1-grayscale and the first pixel column PC_U has a low luminance decreased by 0.55-grayscale. Thus, the luminance difference between the first and second pixel columns PC_U and PC_L, respectively, may be decreased or eliminated.

Referring to FIG. 4, according to the exemplary embodiment #2B, white and blue grayscale data of the white and blue sub-pixels included in the second unit pixel UP2 are increased by 1-grayscale in order that the luminance of the second unit pixel UP2 having a low luminance increases by 0.55-grayscale. Thus, second white and second blue grayscale correction values w2 and b2, respectively, are determined to be “+1”. Then, the second red and second green coefficient correction values r2 and g2, respectively, corresponding to the second unit pixel UP2 and the first red, first green, first blue and first white coefficient correction values r1, g1, b1 and w1, respectively, corresponding to the first unit pixel UP1 are determined to be “0”.

Therefore, the white and blue sub-pixels included in the second pixel column PC_L have a high luminance increased by 1-grayscale and the second pixel column PC_L has a high luminance increased by 0.55-grayscale. Thus, the luminance difference between the first and second pixel columns PC_U and PC_L, respectively, may be decreased or eliminated.

Each of exemplary embodiments #3A and #3B has a 0.65-grayscale difference which is a luminance difference between the first and second pixel columns PC_U and PC_L, respectively. According to the exemplary embodiments #3A and #3B, white, red and blue grayscale data are corrected to compensate for the 0.65-grayscale difference based on the luminance proportion (2:7:1:10) of the red, green, blue and white colors.

Referring to FIG. 4, according to the exemplary embodiment #3A, white, red and blue grayscale data of the white, red and blue pixels included in the first unit pixel UP1 are decreased by 1-grayscale in order that the luminance of the first pixel column PC_U having a high luminance decreases by 0.65-grayscale. Thus, the first white, first red and first blue grayscale correction values w1, r1 and b1, respectively, are determined to be “−1”. Then, the first green coefficient correction value g1 corresponding to the first unit pixel UP1 and the second red, second green, second blue and second white coefficient correction values r2, g2, b2 and w2, respectively, corresponding to the second unit pixel UP2 are determined to be “0”.

Therefore, the white, red and blue sub-pixels included in the first pixel column PC_U have a low luminance decreased by 1-grayscale and the first pixel column PC_U has a low luminance decreased by 0.65-grayscale. Thus, the luminance difference between the first and second pixel columns PC_U and PC_L, respectively, may be decreased or eliminated.

Referring to FIG. 4, according to the exemplary embodiment #3B, white, red and blue grayscale data of the white, red and blue sub-pixels included in the second unit pixel UP2 are increased by 1-grayscale in order that the luminance of the second unit pixel UP2 having a low luminance increases by 0.65-grayscale. Thus, the second white, second red and second blue grayscale correction value w2, r2 and b2, respectively, are determined to be “+1”. Then, the second green coefficient correction value g2 corresponding to the second unit pixel UP2 and the first red, first green, first blue and first white coefficient correction values r1, g1, b1 and w1, respectively, corresponding to the first unit pixel UP1 are determined to be “0”.

Therefore, the white, red and blue sub-pixels included in the second pixel column PC_L have a high luminance increased by 1-grayscale and the second pixel column PC_L has a high luminance increased by 0.65-grayscale. Thus, the luminance difference between the first and second pixel columns PC_U and PC_L, respectively, may be decreased or eliminated.

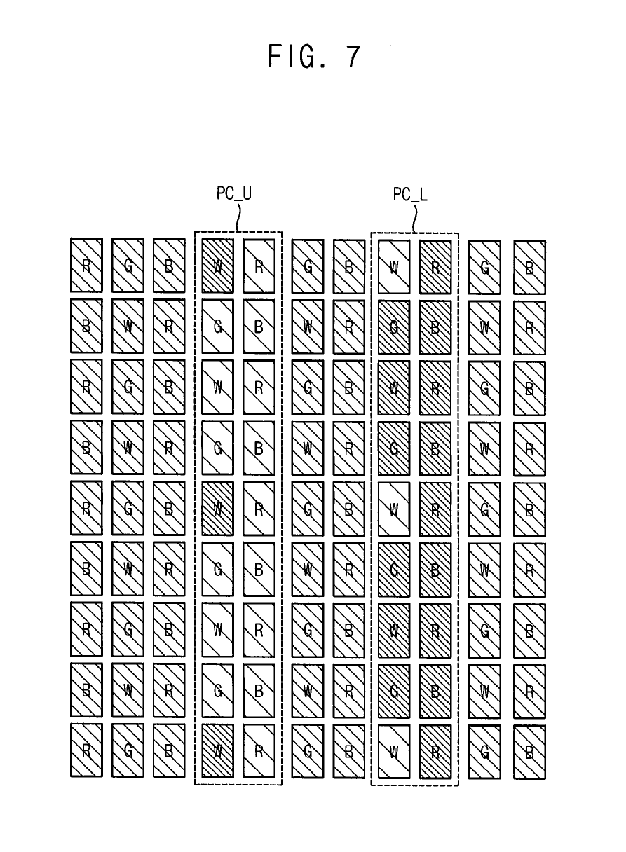

FIG. 7 is a conceptual diagram illustrating a method of correcting the luminance difference according to an exemplary embodiment of the invention.

As described above, according to previous exemplary embodiments, the luminance of one of the first and second pixel columns PC_U and PC_L, respectively, is compensated for in order to compensate for the luminance difference between the first and second pixel columns PC_U and PC_L, respectively. However, according to an exemplary embodiment, luminance of all of the first and second pixel columns PC_U and PC_L, respectively, is compensated for in order to compensate for the luminance difference between the first and second pixel columns PC_U and PC_L, respectively.

For example, the first pixel column PC_U has a luminance higher by 0.25-grayscale than a normal luminance and the second pixel column PC_L has a luminance lower by 0.25-grayscale than the normal luminance. As described above, when the luminance difference between the first and second pixel columns PC_U and PC_L, respectively, is a 0.5-grayscale difference, the luminance of the first pixel column PC_U decreases by the 0.25-grayscale and the luminance of the first pixel column PC_L increases by the 0.25-grayscale according to the exemplary embodiment.

In order to decrease the luminance of the first pixel column PC_U by 0.25-grayscale, the luminance controller 230 shown in FIG. 1 is configured to apply a first white grayscale correction value (w1=−1) to color grayscale data in correspondence to half of the white sub-pixels included in the first pixel column PC_U shown in FIG. 5 for compensating for the luminance difference. Thus, the first pixel column PC_U has a luminance decreased by 0.25-grayscale.

In addition, in order to increase the luminance of the second pixel column PC_L by 0.25-grayscale, the luminance controller 230 shown in FIG. 1 is configured to apply a second white grayscale correction value (w2=+1) to color grayscale data in correspondence to half of the white sub-pixels included in the second pixel column PC_L shown in FIG. 6 for compensating the luminance difference. Thus, the first pixel column PC_U has a luminance increased by 0.25-grayscale.

Therefore, the luminance difference between the first and second luminance columns PC_U and PC_L, respectively, may be decreased or eliminated.

Although not shown in the figures, various luminance differences according to the previous exemplary embodiments may be decreased or eliminated by compensating for the luminance of all of the first and second luminance columns PC_U and PC_L, respectively, as described above relative to FIG. 7.

As described above, according to exemplary embodiments of the invention, the vertical line defect which corresponds to the luminance difference between the first pixel column, including the color sub-pixels, connected to the upper gate line, and the second pixel column, including the color sub-pixels connected to the lower gate line, may be decreased or eliminated. In addition, the color grayscale data of at least one of the red, green, blue and white color sub-pixels included in at least one of the first pixel column and the second pixel column are corrected by the grayscale less than 1-grayscale so that the luminance difference may be decreased or eliminated.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined by the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A display apparatus, comprising:
a display panel including a plurality of color sub-pixels which are arranged as a plurality of sub-pixel columns and a plurality of sub-pixel rows, a first pixel column and a second pixel column comprising a plurality of sub-pixel columns;
a luminance controller configured to correct color grayscale data of at least one color sub-pixel included in at least one of the first and second pixel columns by 1-grayscale based on a luminance difference between the first and second pixel columns; and
a data driver configured to convert the color grayscale data of said at least one color sub-pixel to a data voltage and to provide the data voltage to the display panel.

2. The display apparatus of claim 1, wherein color sub-pixels in a sub-pixel row are alternately connected to an upper gate line disposed at an upper side of the sub-pixel row and to a lower gate line disposed at a lower side of the sub-pixel row;
wherein the first pixel column comprises color sub-pixels of an even number which are connected to corresponding upper gate lines and which are consecutively arranged; and
wherein the second pixel column comprises color sub-pixels of an even number which are connected to corresponding lower gate lines and which are consecutively arranged.

3. The display apparatus of claim 1, wherein the luminance difference corresponds to a grayscale smaller than 1-grayscale.

4. The display apparatus of claim 1, wherein the color sub-pixels comprise red, green, blue and white sub-pixels.

5. The display apparatus of claim 4, wherein the luminance controller determines at least one of red, green, blue and white grayscale data of the red, green, blue and white sub-pixels to compensate for a luminance difference based on a luminance proportion of the red, green, blue and white colors.

6. The display apparatus of claim 4, wherein the luminance controller corrects one of red, green, blue and white grayscale data of the red, green, blue and white sub-pixels in the first pixel column by 1-grayscale, and does not correct red, green, blue and white grayscale data of the red, green, blue and white sub-pixels in the second pixel column.

7. The display apparatus of claim 4, wherein the luminance controller is corrects one of red, green, blue and white grayscale data of the red, green, blue and white sub-pixels in the second pixel column by 1-grayscale, and does not correct red, green, blue and white grayscale data of the red, green, blue and white sub-pixels in the first pixel column.

8. The display apparatus of claim 4, wherein the luminance controller corrects color grayscale data of half of a predetermined color sub-pixel in the first pixel column by 1-grayscale, and corrects color grayscale data of half of the predetermined color sub-pixel in the second pixel column by 1-grayscale.

9. The display apparatus of claim 4, wherein the luminance controller corrects white grayscale data of the white sub-pixels in the first pixel column by 1-grayscale, and does not correct red, green, blue and white grayscale data of the red, green, blue and white sub-pixels in the second pixel column.

10. The display apparatus of claim 4, wherein the luminance controller corrects white grayscale data of the white sub-pixels in the second pixel column by 1-grayscale, and does not correct red, green, blue and white grayscale data of the red, green, blue and white sub-pixels in the first pixel column.

11. The display apparatus of claim 4, wherein the luminance controller corrects white grayscale data of half of the white sub-pixels in the first pixel column by 1-grayscale, and corrects white grayscale data of half of the white sub-pixels in the second pixel column by 1-grayscale.

12. A method of driving a display apparatus, comprising the steps of:
correcting color grayscale data of at least one color sub-pixel included in at least one of first and second pixel columns by 1-grayscale based on a luminance difference between the first and second pixel columns;
providing a display panel including a plurality of color sub-pixels which are arranged as a plurality of sub-pixel columns and a plurality of sub-pixel rows, each of the first and second pixel columns comprising a plurality of sub-pixel columns;
converting the color grayscale data of said at least one color sub-pixel to a data voltage; and
providing the data voltage to the display panel.

13. The method of claim 12, further comprising the step of alternately connecting color sub-pixels in a sub-pixel row to an upper gate line disposed at an upper side of the sub-pixel row and to a lower gate line disposed at a lower side of the sub-pixel row;
providing the first pixel column with color sub-pixels of an even number, connecting the color sub-pixels of the first pixel column to corresponding upper gate lines, and consecutively arranging the color sub-pixels of the first pixel column; and
providing the second pixel column with color sub-pixels of an even number, connecting the color sub-pixels of the second pixel column to corresponding lower gate lines, and consecutively arranging the color sub-pixels of the second pixel column.

14. The method of claim 12, wherein the luminance difference corresponds to a grayscale smaller than 1-grayscale.

15. The method of claim 12, further comprising the steps of:
correcting one of red, green, blue and white grayscale data of the red, green, blue and white sub-pixels in the first pixel column by 1-grayscale; and
not correcting red, green, blue and white grayscale data of the red, green, blue and white sub-pixels in the second pixel column.

16. The method of claim 12, further comprising the steps of:
correcting one of red, green, blue and white grayscale data of the red, green, blue and white sub-pixels in the second pixel column by 1-grayscale; and
not correcting red, green, blue and white grayscale data of the red, green, blue and white sub-pixels in the first pixel column.

17. The method of claim 12, further comprising the steps of:
correcting color grayscale data of half of a predetermined color sub-pixel in the first pixel column by 1-grayscale; and
correcting color grayscale data of half of the predetermined color sub-pixel in the second pixel column by 1-grayscale.

18. The method of claim 12, further comprising the steps of:
correcting white grayscale data of the white sub-pixels in the first pixel column by 1-grayscale; and
not correcting red, green, blue and white grayscale data of the red, green, blue and white sub-pixels in the second pixel column.

19. The method of claim 12, further comprising the steps of:
correcting white grayscale data of the white sub-pixels in the second pixel column by 1-grayscale; and
not correcting red, green, blue and white grayscale data of the red, green, blue and white sub-pixels in the first pixel column.

20. The method of claim 12, further comprising the steps of:
correcting white grayscale data of half of the white sub-pixels in the first pixel column by 1-grayscale; and
correcting white grayscale data of half of the white sub-pixels in the second pixel column by 1-grayscale.
